(19) United States
(12) Patent Application Publication
(10) Pub. No.: US 2024/0341428 A1
(43) Pub. Date: Oct. 17, 2024

(54) PORTABLE CASE FOR OUTDOOR GRILLING ACCESSORIES

(71) Applicant: William W. Braddy, JR., Florence, SC (US)

(72) Inventor: William W. Braddy, JR., Florence, SC (US)

(21) Appl. No.: 18/748,635

(22) Filed: Jun. 20, 2024

Related U.S. Application Data
(63) Continuation-in-part of application No. 17/745,052, filed on May 16, 2022.
(60) Provisional application No. 63/258,651, filed on May 21, 2021.

(51) Int. Cl. A45C 11/00; A45C 13/02; A47J 37/07

(52) U.S. Cl. CPC A45C 11/00; A45C 13/02; A47J 37/0786

(57) ABSTRACT

A durable, lightweight and portable case for organizing and protecting outdoor grilling accessories. The case includes a body assembly having a front body section, a rear body section, a closure for selectively connecting the front body section and the rear body section, and a handle. The case has interior compartments and a supplemental pocket within which a portable solar panel charger is stored.

### I. RELATED APPLICATIONS

The present application is a Continuation-in-Part of U.S. Non-provisional patent application Ser. No. 17/745,052, filed on May 16, 2022, which claims priority to U.S. Provisional Patent Application No. 63/258,651, filed on May 21, 2021, wherein the disclosures both of which incorporated herein by this reference in their entireties.

### II. FIELD OF THE INVENTION

The present application discloses and describes a durable, lightweight case for organizing, storing, protecting, and transporting outdoor grilling accessories.

### III. MOTIVATION OF THE INVENTOR

Presently, the prior art discloses devices protecting carpentry and automotive tools, painting accessories, toiletries, and the like. However, the prior art fails to teach or disclose durable, lightweight devices for organizing, storing, protecting, and transporting outdoor grilling accessories in a quick, easy, and efficient manner.

Accordingly, a need continues to exist and is recognized for improvements to devices for organizing and protecting outdoor cooking and grilling accessories which are not only strong and durable, but lightweight and portable.

This application presents claims and embodiments that fulfill a need or needs not yet satisfied by the products, inventions and methods previously or presently available. In particular, the claims and embodiments disclosed herein describe a portable case for securably storing and organizing outdoor grilling accessories, the case comprises a body assembly comprising a front body section; a rear body section; a closure for selectively connecting the front body section and the rear body section; and a handle, the body assembly opens to a planar configuration, the front body section comprises an interior front compartment comprising a large, elastic meshed pocket, the rear body section comprises an interior rear compartment comprising a series of retainers for securably storing a variety of grilling accessories, the interior rear compartment further comprises a plurality of herb and spice jar retainers comprising a series of elastic loops, the series of elastic loops is positioned in a longitudinally-aligned spaced orientation, and wherein the rear body section further comprises a supplemental large elastic meshed pocket sizably dimensioned for securably storing and organizing at least one larger-sized outdoor grilling accessory in combination with one or more outdoor grilling accessories, the supplemental large pocket is affixed superjacent an outer surface of the bottom wall of the rear body section, the portable case providing unanticipated and nonobvious combination of features distinguished from the products, devices, apparatuses, inventions, and methods preexisting in the art. The applicant is unaware of any device, apparatus, method, disclosure or reference that discloses the features of the claims and embodiments disclosed herein.

### IV. SUMMARY OF THE INVENTION

A durable, lightweight, portable case for outdoor grilling accessories is disclosed. According to one embodiment, the case comprises a body assembly comprising a cuboid or rectangular prism shape. The body assembly is constructed of a lightweight, flexible, durable material characterized as having a high tensile strength. The body assembly comprises a front body section, a rear body section, a handle, and a closure (such as a zipper assembly) adapted to selectively connect the front body section and the rear body section. The front body section and the rear body section are integrally joined via an interface defining a fold section about which the front body section and the rear body section may be folded to a fully open condition, oriented planar to a horizontal surface, such as a tabletop. After use, the body assembly may be placed in a closed condition by folding the front body section and the rear body section forward in a converging direction until front and rear body sections are positioned in an appositional orientation.

The front body section comprises an interior front compartment comprising a large, elastic meshed pocket. The rear body section comprises an interior rear compartment comprising a series of retainers for securably storing a variety of grilling accessories.

The interior rear compartment further comprises a plurality of herb and spice jar retainers comprising a series of straps or elastic loops. The series of elastic loops is positioned in a longitudinally-aligned spaced orientation.

The rear body section further comprises a supplemental large elastic meshed pocket sizably dimensioned for securably storing and organizing at least one larger-sized outdoor grilling accessory in combination with one or more outdoor grilling accessories. The supplemental large pocket is affixed superjacent an outer surface of the bottom wall of the rear body section.

According to one embodiment, a water repellant liner is disposed superpositional an inner surface of the front compartment of the front body section and an inner surface of the rear compartment of the rear body section.

According to another embodiment, an insulating layer is disposed between the water repellent liner and the inner surface of the front compartment of the front body section and the inner surface of the rear compartment of the rear body section.

### V. BRIEF DESCRIPTION OF THE DRAWING(S)

The advantages and features of the present invention will become better understood with reference to the following more detailed description and claims taken in conjunction with the accompanying drawings, in which like elements are identified with like symbols, and in which:

FIG. 1 depicts a right front perspective view of a case, in accordance to one embodiment of the present invention;

FIG. 1A is a right side elevational view of the case in FIG. 1;

FIG. 1B is a left side elevational view of the case in

FIG. 1;

FIG. 2 is a top plan view of a case shown in a fully open condition, in accordance to one embodiment of the present invention;

FIG. 3 is another top plan view of the case shown in a fully open condition;

FIG. 4 is an exploded view showing a front crescent-shaped strap detachably coupled to a rear crescent-shaped strap so as to form a handle for carrying the case of the present invention, in accordance to one embodiment thereof;

FIG. 5 is a left, top perspective view of the case shown in a fully open condition, according to one embodiment of the present invention;

FIG. 6 is a top plan view of the case shown in a fully open condition illustrating a large pocket provided in the front compartment thereof and a series of retainers provided in the rear compartment thereof, in accordance to one embodiment of the present invention;

FIG. 7 is a top plan view of the case shown in a fully open condition illustrating a plurality of herb and spice jar retainers provided in the rear compartment thereof, in accordance to one embodiment of the present invention;

FIG. 8 illustrates a rear perspective view of the case, in accordance to one embodiment of the present invention;

FIG. 9 is a top plan view of a case disposed with a water repellant liner, in accordance to another embodiment of the present invention;

FIG. 10 is a cross-sectional view taken along lines 10-10 of FIG. 9;

FIG. 11 is top plan view of a case disposed with a water repellant liner and an insulating layer, in accordance to another embodiment of the present invention;

FIG. 12 is a cross-sectional view taken along lines 12-12 of FIG. 11;

FIG. 13 is a top plan view of a solar panel charger, in accordance to one embodiment of the present invention;

FIG. 13A is top plan view of a solar panel charger, in accordance to another embodiment of the present invention;

FIG. 13B is an inset detailed view of a single photovoltaic cell of the solar panel charger illustrated in FIG. 13A;

FIG. 14 illustrates a male USB connector, particularly a USB 2.0 type A connector;

FIG. 14A illustrates a male USB connector, particularly a USB 3.0 type A connector;

FIG. 15 illustrates additional male USB type connectors;

FIG. 15A is illustrates a male interface connector, particularly, a lightning connector;

FIG. 16 is a top plan view of a mobile electronic device, particularly, a mobile phone; and

FIG. 16A is a top plan view of another mobile electronic device, namely a computer tablet.

### VI. DESCRIPTION OF THE EMBODIMENT(S)

It will be readily understood that the components of the present invention, as generally described and illustrated in the figures herein, may be arranged and designed in a wide variety of different configurations. Thus, the following detailed description of the embodiments, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

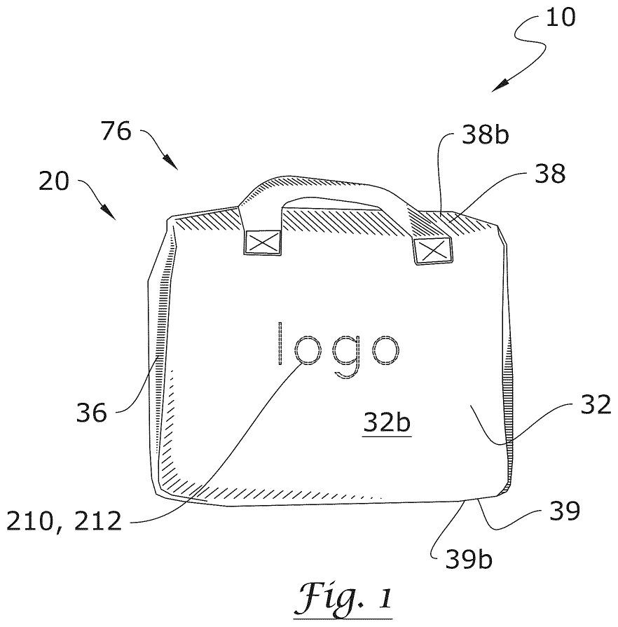

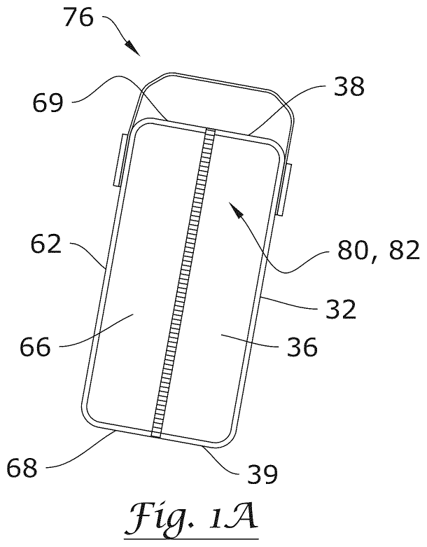

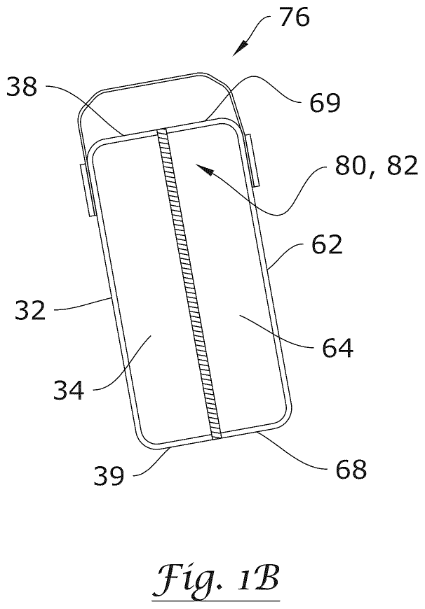

In accordance with FIGS. 1-5, and 8, a portable case 10 for outdoor grilling accessories is disclosed. For purposes of this disclosure, outdoor grilling accessories 160 are intended to include, but are not limited to, spray bottles 164, cutlery (e.g., forks, knives, and spoons), food preparation and cooking utensils 162 (e.g., tongs 162a, spatulas 162b, and basting brushes), napkins, flashlight, lighter wand, bottles of alcohol (e.g., bourbon, whiskey blend, vodka, gin, scotch, rum, wine, and beer), bottle opener 163, herb and spice jars 165, and condiment bottles such as bottles or containers containing barbecue sauce, steak sauce, marinade, mustard, ketchup, relish, mayonnaise, vinegar, lemon juice, and the like. Outdoor grilling accessories 160 are further intended to include larger-sized outdoor grilling accessories 160a, such as including, but not limited to, a cutting board 166, plates 167, small towels 168, and aprons.

The portable case 10 for outdoor grilling accessories, hereinafter “case 10”, comprises a body assembly 20 comprising a cuboid or rectangular prism shape. The body assembly 20 is constructed of a 41 lightweight, flexible, durable material characterized as having a high tensile strength. The body assembly 20 may be constructed of a textile material or materials selected from the group which includes, but is not limited to, cotton, microfiber, nylon, polyester, polyamide, viscose, wool, cashmere, mohair, rayon, silk, satin, acrylic, linen, flax, hemp, cellulose, wood pulp, cellulose acetate or triacetate, nylon 6, nylon 66, and any combination thereof.

In accordance to another embodiment, the body assembly 20 is constructed of a flame-retardant material, or is otherwise disposed with a layer of flame retardant material. The layer of flame retardant material may comprise an organic substance and phosphorus, wherein the phosphorus may be bonded to a side chain of the organic substance. The organic substance may comprise a carboxyl group (COOH).

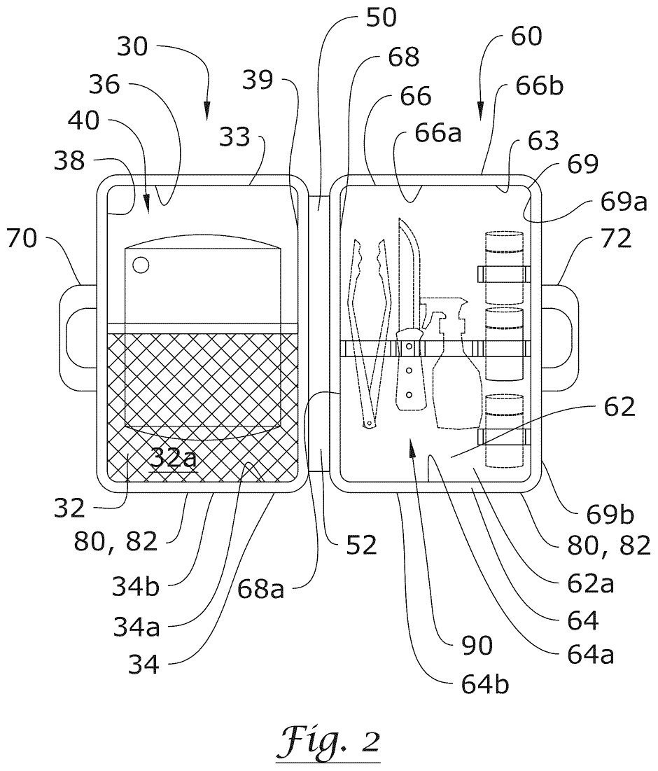

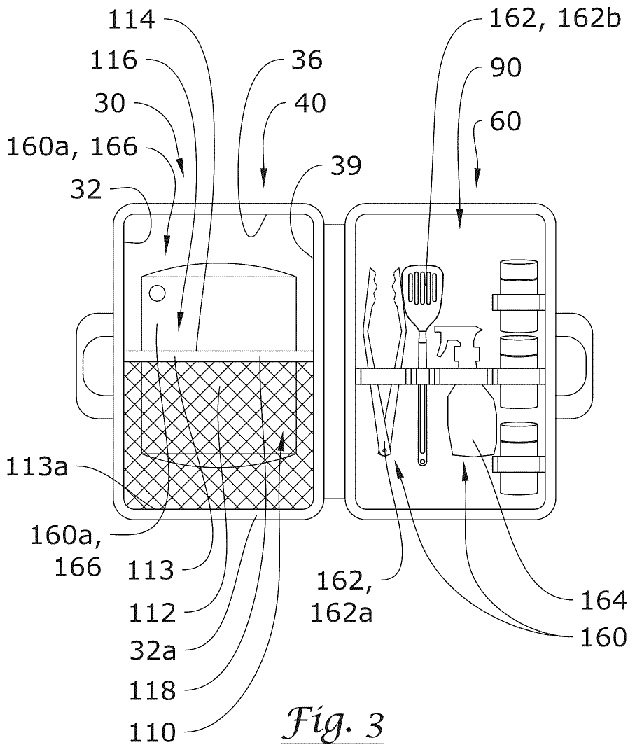

The body assembly 20 comprises a front body section 30, a rear body section 60, and a closure 80 adapted to selectively connect the front body section 30 and the rear body section 60. The front body section 30 and the rear body section 60 are integrally joined via an interface 50, wherein the interface 50 defines a fold section 52 about which the front body section 30 and the rear body section 60 may be folded. The body assembly 20 may be placed in a fully open condition atop a horizontal surface (such as the top surface of a picnic or dining table) by folding the front body section 30 and the rear body section 60 rearward in opposing directions to a planar orientation, as shown in FIGS. 2 and 3. The body assembly 20 may be placed in a closed condition by folding the front body section 30 and the rear body section 60 forward in a converging direction until front and rear body sections 30 and 60 are positioned in an appositional orientation, as shown in FIGS. 1A and 1B. After positioning the body assembly 20 in the closed condition, the front body section 30 may be selectively connected to the rear body section 60 via the closure 80, thereby enabling the body assembly 20 to be secured in the closed condition.

The front body section 30 comprises a bottom wall 32 having a perimetric interface 33 from which a left sidewall 34, a right sidewall 36, a forward sidewall 38, and a rear sidewall 39 extend upward integrally enclosing the bottom wall 32 and forming a front compartment 40. The left sidewall 34, right sidewall 36, forward sidewall 38, and rear sidewall 39 collectively form a contiguous, continuous upper edge 39a or lip.

The bottom wall 32 comprises an inner surface 32a and an outer surface 32b, the left sidewall 34 comprises an inner surface 34a and an outer surface 34b, the right sidewall 36 comprises an inner surface 36a and an outer surface 326b, the forward sidewall 38 comprises an inner surface 38a and an outer surface 38b, and the rear sidewall 39 comprises an inner surface 39a and an outer surface 39b.

A front crescent-shaped strap 70 is suitably affixed via a connection element 74 (such as via stitching using threads) to the outer surface 32b of bottom wall 32 along an upper region thereof, adjacent the forward sidewall 38.

The rear body section 60 comprises a bottom wall 62 having a perimetric interface 63 from which a left sidewall 64, a right sidewall 66, a forward sidewall 68, and a rear sidewall 69 extend upward integrally enclosing the bottom wall 62 and forming a rear compartment 90. The left sidewall 64, right sidewall 66, forward sidewall 68, and rear sidewall 69 collectively form a contiguous, continuous upper edge 69c or lip.

The bottom wall 62 comprises an inner surface 62a and an outer surface 62b, the left sidewall 64 comprises an inner surface 64a and an outer surface 64b, the right sidewall 66 comprises an inner surface 66a and an outer surface 66b, the forward sidewall 68 comprises an inner surface 68a and an outer surface 68b, and the rear sidewall 69 comprises an inner surface 69a and an outer surface 69b.

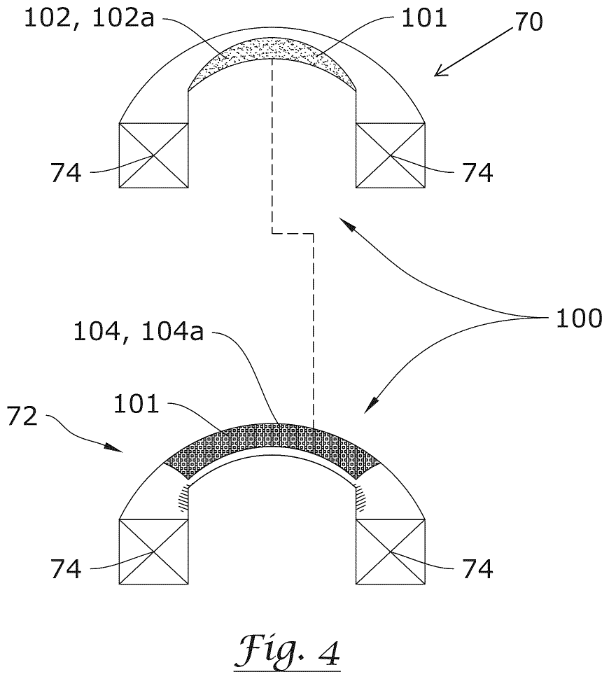

A rear crescent-shaped strap 72 is suitably affixed via the connection element 74 to the outer surface of bottom wall 62 along an upper region thereof, adjacent the rear sidewall 69. The front crescent-shaped strap 70 is detachably coupled to the rear crescent-shaped strap 72 forming a handle 76 for carrying the case 10. The front crescent-shaped strap 70 is detachably coupled to the rear crescent-shaped strap 72 via a coupling means 100. The coupling means 100 comprises a coupling element 102 disposed on a lower surface of the front crescent-shaped strap 70 and a complementary coupling element 104 disposed on an upper surface of the rear crescent-shaped strap 72, as best illustrated in FIG. 4. Accordingly, coupling means 100 mutually couples the front crescent-shaped strap 70 to the rear crescent-shaped strap 72 through the conjoining and/or coupling of complementary elements selected for use as the coupling means 100.

Thus, the coupling means 100 is utilized for detachably coupling and joining the front crescent-shaped strap 70 and the rear crescent-shaped strap 72, and is achieved using one or more coupling elements 102 and 104. These coupling elements 102 and 104 may include, singularly or in combination, buttons, studs, toggles, eyelets, buckles, zippers, snap fasteners, hook-and-loop fasteners, magnets, grommets, and other complementary type or matching connector devices and systems.

In accordance to one embodiment shown in FIGS. 1-5, and 8, the coupling means 100 comprises hook-and-loop fastener material 101, wherein the hook portion 104a thereof is disposed on the upper surface of the rear crescent-shaped strap 72, and the loop portion 102a thereof is disposed on the lower surface of the front crescent-shaped strap 70, or vice-versa.

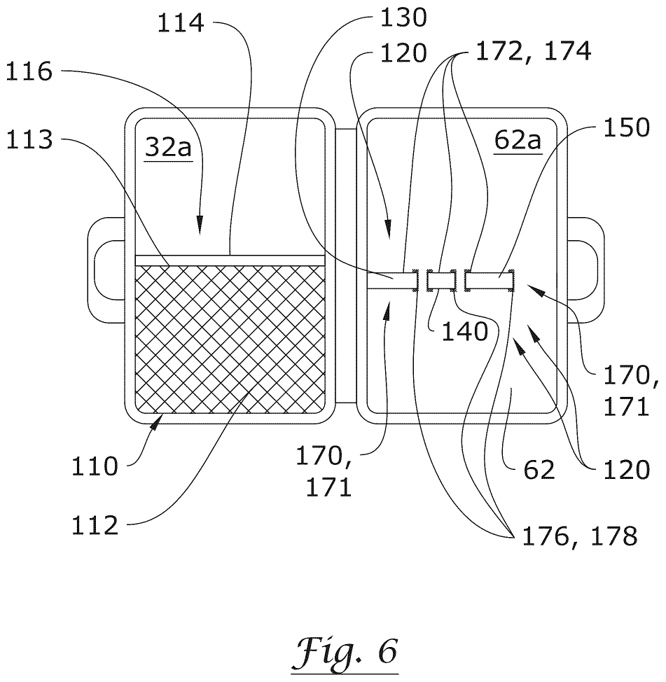

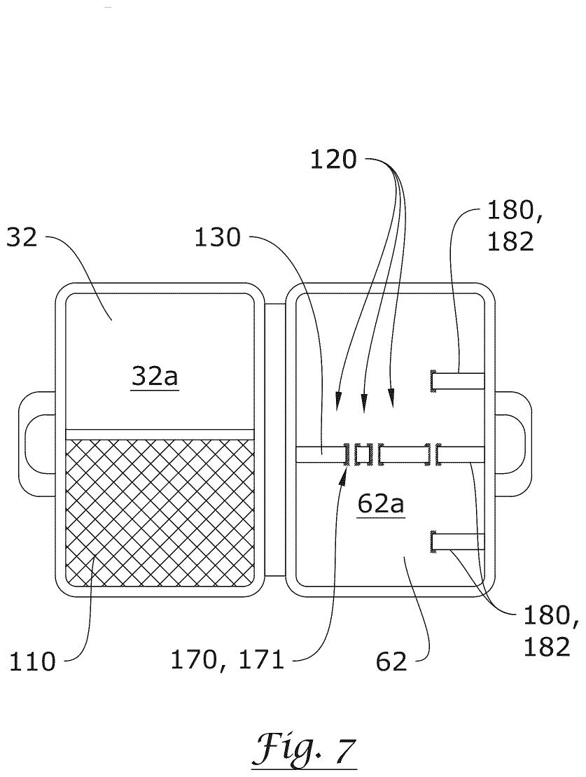

As previously described, when user desires to position the body assembly 20 in a secured, closed condition, the front body section 30 is selectively connected to the rear body section 60 via the closure 80. The closure 80 is suitably affixed along the upper continuous upper edge 39c of the front body section 30 and the continuous upper edge 69c of the rear body section 60. In accordance to one embodiment, the closure 80 is a zipper assembly 82, as shown in FIGS. 1-9, but may be other closing or sealing devices. For example, the closure 80 may be selected from the group which includes, but is not limited to, a hook-and-loop type fastener, snap fasteners, buckles, buttons, studs, toggles, eyelets, magnets, and grommets.

Referring now more particularly to FIGS. 2, 3, and 5-7, the front compartment 40 of the front body section 30 comprises a large pocket 110 for securably storing and organizing at least one larger-sized outdoor grilling accessory 160a. The large pocket 110 is suitably affixed superjacent the inner surface 32a of the bottom wall 32. According to one embodiment, the large pocket 110 dimensionally occupies a substantial majority of the surface area defining the inner surface 32a of bottom wall 32. The large pocket 110 comprises a panel 112 comprising an upper end 113 opposing a lower end 113a, the upper end 113 having an openable mouth 114 providing direct open passage into an interior storage compartment 116 within which the selected accessory 160a is stored. The lower end 113a extends contiguous the perimetric interface 33 of the bottom wall 32. The panel 112 is constructed of a durable, elastic mesh or web textile material. The durable, elastic mesh material utilized for constructing the panel 112 is configured for applying and maintaining a compressive force against the accessory 160a stored within the compartment 116, thereby securably retaining, storing, and organizing the selected accessory 160a in the large pocket 110 of the case 10 in a quick, easy, and efficient manner.

The panel 112 may be constructed of a natural or synthetic textile material, or a combination thereof. The panel 112 may be constructed of a material or combination of materials selected from the group which includes, but is not limited to, cotton, microfiber, nylon, polyester, viscose, wool, cashmere, mohair, rayon, silk, satin, acrylic, linen, flax, hemp, cellulose, wood pulp, cellulose acetate or triacetate, nylon 6, nylon 66, spandex, elastane, Lycra® a polymerized organic compound, an elastomeric polymer, polyolefins, polyisocyanurate, alkenyl aromatic polymers, cellulosic polymers, polycarbonates, polyetherimides, polyamides, polyesters, polyvinylidene chloride, polymethylmethacrylate, polyurethanes, polyisocyanurates, and phenolics.

Suitable polymerized organic compounds may include polychloroprene, and neoprene. Suitable elastomeric polymers may include ethylene-vinyl acetate, thermoplastic urethane, styrene-butadiene rubber, polyurethane, flexible polyvinyl chloride, and acrylic/acrylate. Suitable polyolefins include polyethylene and polypropylene.

The openable mouth 114 at the upper end 113 of the large pocket 110 is oriented perpendicular to the rear sidewall 39 and proximately parallel to the right sidewall 36 of the front compartment 40. The upper end 113 forming the mouth 114 is constructed of a durable, elastic fabric band 118. The band 118 is characterized as having returnably-resilient properties. Thus, in a resting position, the band 118 lies tautly superjacent the inner surface 32a of the bottom wall 32. When user desires to place a desired larger-sized outdoor grilling accessory 160a, such as a cutting board 161 or one or more plate(s) 162, in the large pocket 110, user pulls the band 118 at the mouth 114 of large pocket 110 in a direction opposing the inner surface 32a of bottom wall 32 stretching the band 118 and opening the mouth 114 to allow the grilling accessory 160a to be inserted therethrough and into the interior storage compartment 116 of large pocket 110. Thereafter, user releases the band 118, wherein the band 118 elastically-returning to a taut position a and applying compressive force against the larger-sized outdoor grilling accessory 160a or against the inner surface 32a of bottom wall 32 above the larger-sized outdoor grilling accessory 160a, thereby securably retaining and storing the selected accessory 160a in the case 10.

Alternative means for securing the openable mouth 114 in a closed condition are envisioned. In accordance to one exemplary securing means, the openable mouth 114 may be closed via a draw string or tether disposed (or otherwise laced) within an annular narrow sleeve or pocket formed, such as via conventional sewing method, about the upper end 113 of the openable mouth 114.

Further alternative means for securing the mouth 114 in a closed condition may include, but are not limited to, hook-and-loop fasteners, buttons, studs, toggles, eyelets, buckles, zippers, snap fasteners, magnets, grommets, and other complementary type or matching connector devices and systems.

The rear compartment 90 of the rear body section 60 comprises a series of retainers 120 for securably storing and organizing outdoor grilling accessories 160. In accordance to one embodiment, the series of retainers 120 comprises a plurality of straps 130, 140, and 150 spatially-aligned and oriented intermediate about and perpendicular to the forward sidewall 68 of the rear body section 60.

Each of the plurality of straps 130, 140, and 150 comprises one end opposing a free end. One end of each of the plurality of straps 130, 140, and 150 is suitably affixed (such as via stitching using threads) to the inner surface 62a of the bottom wall 62 of the rear body section 60. The free end of each of the plurality of straps 130, 140, and 150 is detachably coupled to the inner surface 62a of the bottom wall 62 via a coupling means 170.

The coupling means 170 comprises a coupling element 172 disposed on a lower surface of the free end of each of the plurality of straps 130, 140, and 150, and a complementary coupling element 176 disposed on the inner surface 62a of the bottom wall 62. Accordingly, coupling means 170 mutually couples the free end of each of the plurality of straps 130, 140, and 150 to the inner surface 62a of the bottom wall 62 through the conjoining and/or coupling of complementary elements selected for use as the coupling means 170.

In accordance to one embodiment shown in FIGS. 2-3, and 5-7, the coupling means 170 comprises hook-and-loop fastener material 171. Coupling element 172 comprises the loop portion 174 of the hook-and-loop fastener material 171 disposed on the lower surface of the free end of each of the plurality of straps 130, 140, and 150. The complementary coupling element 176 comprises the hook portion 178 of the hook-and-loop fastener material 171 disposed on the inner surface 62a of the bottom wall 62, or vice-versa.

It is envisioned coupling elements 172 and 174 may comprise other fastening and connecting devices. These alternative fastening and connecting devices may include, singularly or in combination, buttons, studs, toggles, eyelets, buckles, zippers, snap fasteners, hook-and-loop fasteners, magnets, grommets, and other complementary type or matching connector devices and systems.

To operate the series of retainers 120 for securably retaining, storing and organizing outdoor grilling accessories 160, selectively-desired outdoor grilling accessories 160 are positioned in a spaced, horizontal orientation atop the inner surface 62a of bottom wall 62, as depicted according to one exemplary embodiment shown in FIGS. 2-3, and 5-7. In further accordance to the exemplary embodiment illustrated in FIG. 3, tongs 162a, spatula 162b, and spray bottle 164 are spatially-arranged, horizontally, respectively, atop the inner surface 62a of the bottom wall 62. The plurality of straps 130, 140, and 150 overlaps the tongs 162a, spatula 162b, and spray bottle 164, respectively, in a snug, taut manner, and the free end of each of the plurality of straps 130, 140, and 150 is detachably coupled to the inner surface 62a of the bottom wall 62 via the coupling means 170, thereby securably retaining, storing and organizing the tongs 162a, spatula 162b, and spray bottle 164 in the case 10.

For purposes of this disclosure, the terms “snug” and “snug-fit” are each defined as a substantially-intimate, close-fitting relationship.

Referring now to FIGS. 2-3, 5, and 7, the rear compartment 90 of the rear body section 60 further comprises a plurality of herb and spice jar retainers 180, the retainers 180 comprising a series of elastic loops 182 suitably affixed (such as via stitching using threads) superpositional the inner surface 62a of the bottom wall 62 of the rear body section 60 in a longitudinally-aligned spaced orientation, adjacent the rear sidewall 69 of the rear body section 60 and perpendicular to the plurality of straps 130, 140, and 150. The series of elastic loops 182 are sizably-dimensioned and adapted for slidably-receiving and retaining commercially-available herb and spice jars 165 in a snug-fit, secured manner. Specifically, the elastic loops 182 are each designed and configured to snugly encompass the external circumferential sidewall of a commercially-available herb and spice jar 165. The elastic loops 182 are each designed and configured to snugly encompass the external circumferential sidewall of a commercially-available herb and spice jar 165 comprising a diametral measure in a range comprising 3.50 cm to 5.50 cm, in a range preferably comprising 4.00 cm to 5.00 cm, and in a range most preferably comprising 4.25 cm to 4.75 cm. The elastic loops 182 are each further designed and configured to slidably-receive and securably retain snugly a commercially-available herb and spice jar 165 comprising a length measuring in a range comprising 7.00 cm to 11.00 cm, in a range preferably comprising 7.88 cm to 10.13 cm, and in a range most preferably comprising 8.75 cm to 9.25 cm.

In accordance to another embodiment, the plurality of herb and spice jar retainers may comprise a series of straps, wherein each strap includes one end opposing a free end. One end of each of the plurality of straps is suitably affixed (such as via stitching using threads) to the inner surface 62a of the bottom wall 62 of the rear body section 60. The free end of each of the plurality of straps is detachably coupled to the inner surface 62a of the bottom wall 62 via a coupling means 170.

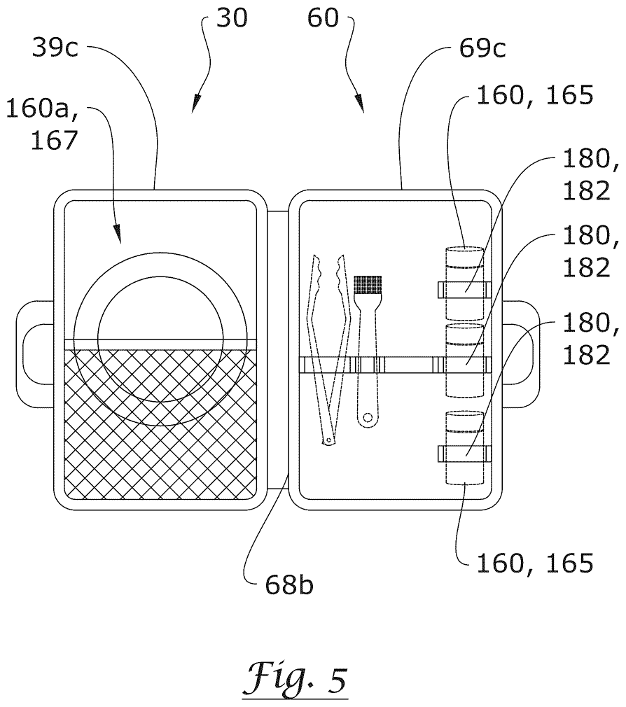

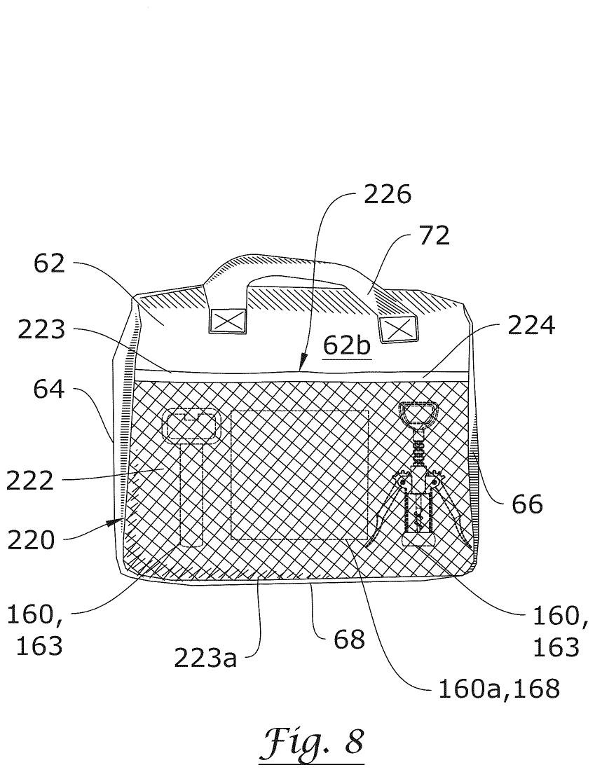

In reference to FIGS. 2 and 5, and more particularly to FIG. 8, a supplemental large pocket 220 for securably storing and organizing at least one larger-sized outdoor grilling accessory 160a is suitably affixed superjacent the outer surface 62b of the bottom wall 62 of the rear body section 60. The supplemental large pocket 220 is sizably dimensioned for securably storing at least one larger-sized outdoor grilling accessory 160a in combination with one or more outdoor grilling accessories 160. According to one embodiment, the supplemental large pocket 220 occupies a substantial majority of the surface area defining the outer surface 62b of the bottom wall 62. The supplemental large pocket 220 comprises a panel 222 comprising an upper end 223 opposing a lower end 223a, the upper end 223 having an openable mouth 224 providing direct open passage into an interior storage compartment 226 within which the selected accessory 160a is stored. The lower end 223a extends contiguous the perimetric interface 63 along the forward sidewall 68 of the bottom wall 62. The upper end 223 of panel 222 extends upwardly, terminating below the rear crescent-shaped strap 72. Opposing sides of the panel 222 extend contiguous the perimetric interface 63 along the left and right sidewalls 64 and 66, respectively, of the bottom wall 62.

The panel 222 is constructed of a durable, elastic mesh or web textile material. The durable, elastic mesh material utilized for constructing the panel 222 is configured for maintaining a compressive force against the accessory 160a stored within the compartment 226, thereby securably retaining, storing, and organizing the selected accessory 160a in the supplemental large pocket 220 of the case 10 in a quick, easy, and efficient manner. For purposes of brevity and obviating redundancy, the panel 222 may be constructed from a material or combinations of materials suitable for constructing the panel 112 of the large pocket 110, as previously described.

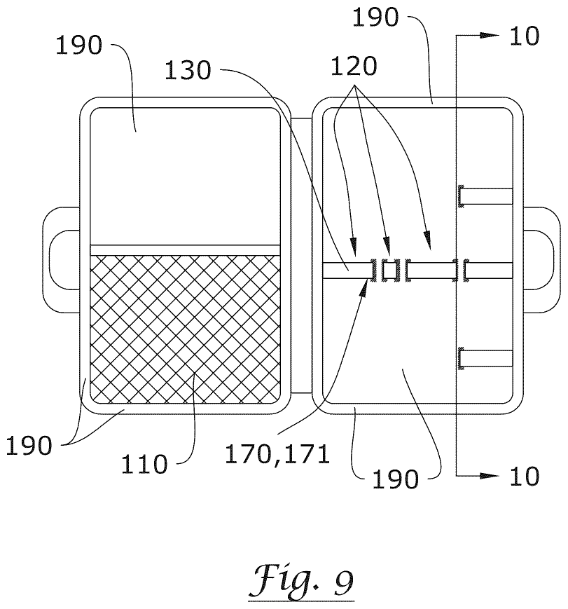

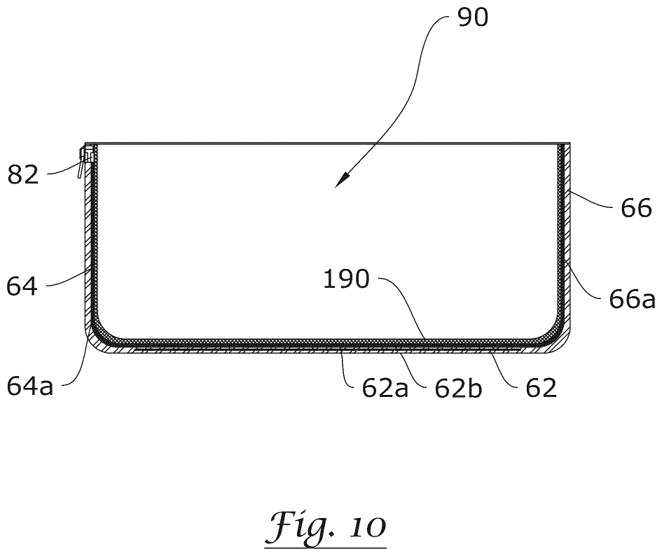

Referring now more particularly to FIGS. 9 and 10, the body assembly 20 further comprises a water repellant liner 190 disposed superpositional the inner surface 32a of the bottom wall 32, the inner surface 34a of left sidewall 34, the inner surface 36a of right sidewall 36, the inner surface 38a of forward sidewall 38, and the inner surface 39a of rear sidewall 39 of the front body section 30. The water repellant liner 190 is also disposed superpositional the inner surface 62a of bottom wall 62, the inner surface 64a of left sidewall 64, the inner surface 66a of right sidewall 66, the inner surface 68a of forward sidewall 68, and the inner surface 69a of rear sidewall 69 of the rear body section 60.

The water repellant liner 190 may be constructed of a variety of conventionally employed materials imparting durable, water repellent properties, such as closely woven textile fabrics which may be formed of nylon or other synthetic, natural, or blends of fibers, or the like, and may be polymer or plastic coated.

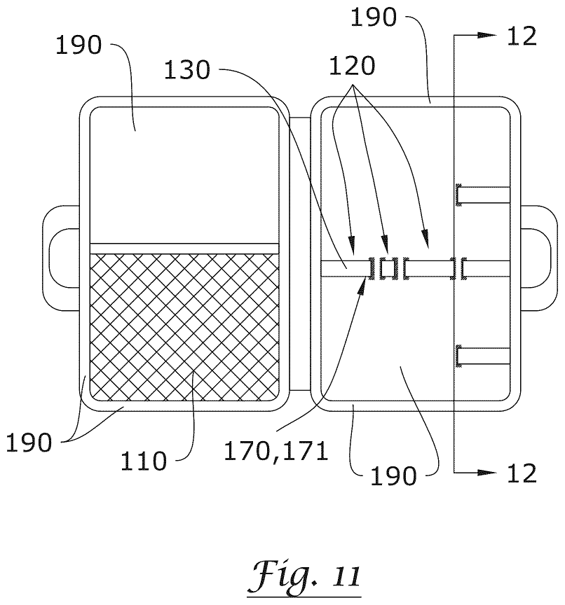

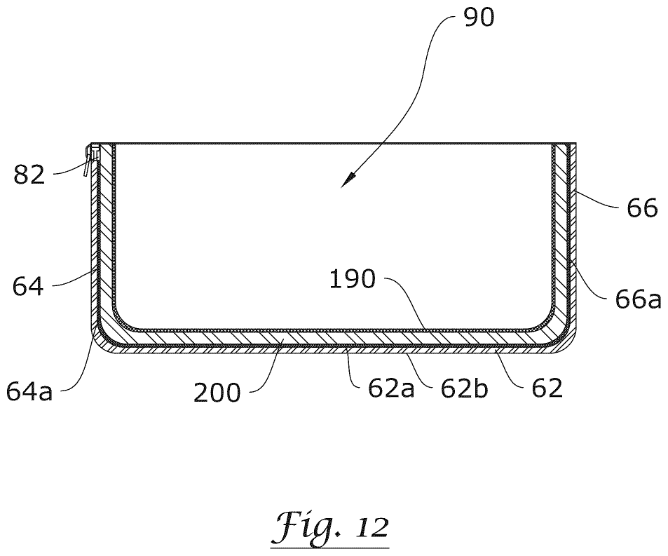

In reference to FIGS. 11 and 12, the body assembly 20 further comprises an insulating layer 200 disposed between the water repellent liner 190 and the bottom wall 32, left sidewall 34, right sidewall 36, forward sidewall 38, and rear sidewall 39 of the front body section 30, and the bottom wall 62, left sidewall 64, right sidewall 66, forward sidewall 68, and rear sidewall 69 of the rear body section 60.

More specifically, the insulating layer 200 is disposed between the water repellent liner 190 and the inner surface 32a of the bottom wall 32, the inner surface 34a of left sidewall 34, the inner surface 36a of right sidewall 36, the inner surface 38a of forward sidewall 38, and the inner surface 39a of rear sidewall 39 of the front body section 30, and the inner surface 62a of bottom wall 62, the inner surface 64a of left sidewall 64, the inner surface 66a of right sidewall 66, the inner surface 68a of forward sidewall 68, and the inner surface 69a of rear sidewall 69 of the rear body section 60. The insulating layer 200 is constructed of a closed cellular foam material, such as vinyl nitrile (nitrile polyvinyl chloride blend), or any other suitable blend. Vinyl nitrile is an excellent thermal insulator, and thus assists in maintaining the internal temperature of the front and rear compartments 40 and 90. The insulating layer 200 also imparts protection to fragile accessories, such as glassware.

In reference to FIG. 1, indicia 210 in the form of a trademark or logo 212 may be disposed on the outer surface 32b of the bottom wall 32 of the front body section 30 (as illustrated), or on the outer surface 62b of the bottom wall 62 of the rear body section 60.

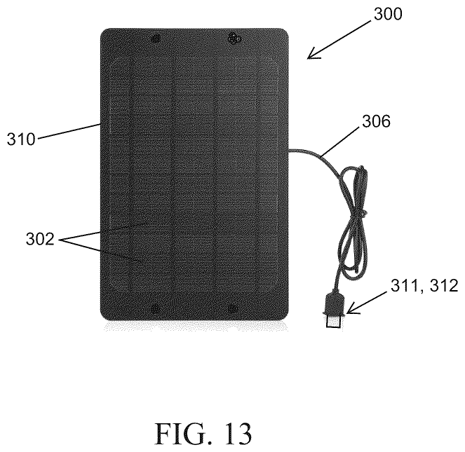

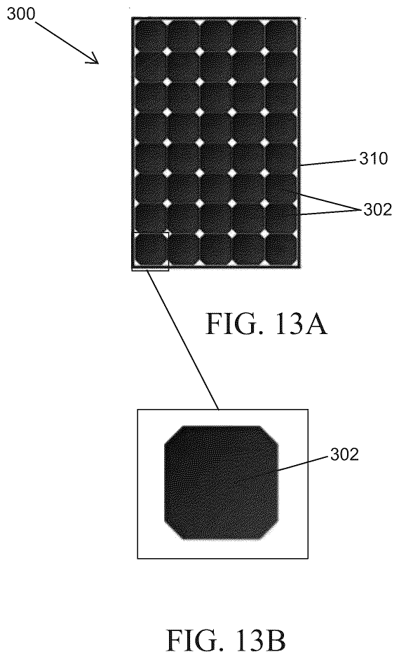

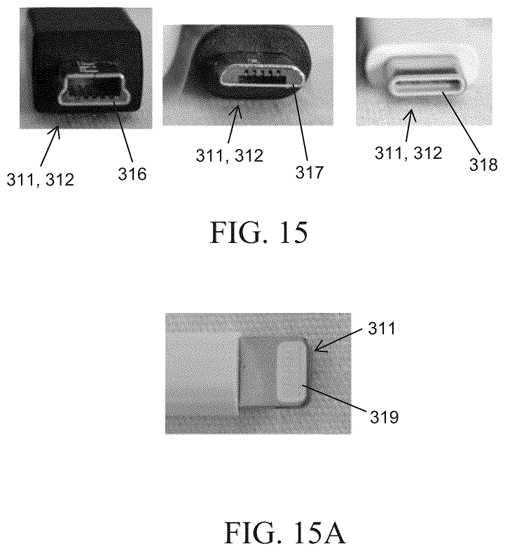

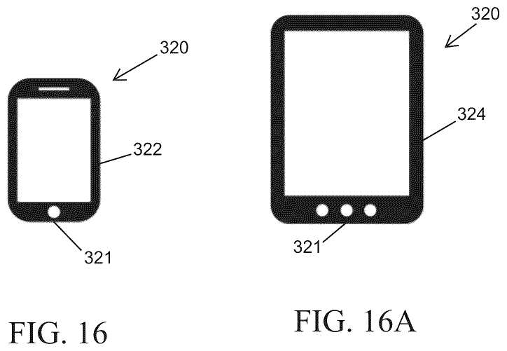

Referring now more particularly to FIGS. 13-16A, a lightweight and portable solar panel charger 300 is disclosed. The solar panel charger 300 is adapted and configured to charge mobile electronic devices 320, such as including, but not limited to, mobile phones 322, computer tablets 324 or electronic book readers (such as iPad® and Kindle®), cameras, appliances, and other mobile electronic devices. In accordance to one embodiment, the charger 300 may be described as a 5 volts (V), 6 watts (W) charger. However, other voltage and wattage measures for the charger 320 are envisioned, and therefore within the spirit and scope of the present application.

The charger 300 is sizably dimensioned to fit inside and be securably stored within the supplemental large pocket 220 of the rear body section 60 of the body assembly 20 of the case 10. As previously described, the supplemental large pocket 220 is constructed of a durable, elastic mesh or web textile material. The durable, elastic mesh or web textile material applies and maintains a compressive force against the solar panel charger 300 stored inside the supplemental large pocket, thereby securably retaining, storing, and organizing the charger 300.

The charger 300 is constructed of materials, components, and elements commonly known by those possessing ordinary skill in the art. For example, the charger 300 is constructed of monocrystalline or polycrystalline material comprising a plurality of photovoltaic cells 302 interconnected forming a panel 310. Each photovoltaic cell 302 comprises a plurality of layers comprising a pair of semiconductors, namely an upper semiconductor and a lower semiconductor. The upper and lower semiconductors are positioned central in the photovoltaic cell 302. The upper semiconductor is a negative layer having atoms comprising electrons carrying a negative charge. The bottom semiconductor is a positive layer having atoms missing electrons. When sunlight (or solar radiation) shines on, or otherwise is directed to, the top semiconductor, loose electrons therein become excited, are knocked loose, and attracted to the positive layer beneath the upper semiconductor, thereby forming a barrier between the upper semiconductor and the lower semiconductor (or two layers), and causing the upper semiconductor and the negative semiconductor to force the electrons to travel around the photovoltaic cell 302, thus creating an electric current.

Next, the top and bottom semiconductors forcibly expel the electric current, namely direct current (DC), from the photovoltaic cell 302 which passes therefrom into an electrical load, wherein the electrical load captures the electric energy produced by the photovoltaic cell 302. Electrons eventually re-enter the photovoltaic cell 302, and the above-described process repeats.

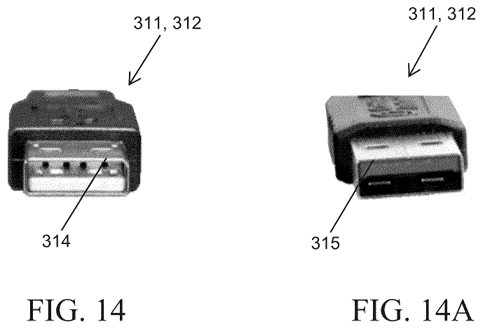

The DC electrical energy generated by the panel 310 is transmitted from the electrical load and received by a central inverter (or micro inverter), at which the DC electrical energy is converted into alternating current (AC) electrical energy usable by mobile electronic devices 320 and appliances. The DC electrical energy is transmitted from the inverter via insulated wiring 306 electrically connected thereto. The wiring 306 terminates into a male interface connector 311, such as a universal serial bus (USB) connector 312, adapted to be received in a type and size-fit corresponding manner in the charging port 321 of the mobile electronic device 320 or appliance. More specifically, and in reference to FIGS. 14 and 14A, the male interface connector 311 may be selected from the group which includes, but is not limited to, a USB 2.0 type A connector 314, a USB 3.0 type A connector 315, mini-USB type B connector 316, a micro-USB type B connector 317, a USB-C connector 318, and a lightning connector 319.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations.

Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. A portable case for securably storing and organizing outdoor grilling accessories, the case comprising:
a body assembly comprising a cuboid or rectangular prism shape, the body assembly comprises:
a front body section, the front body section comprises a bottom wall, the bottom wall comprising a perimetric interface from which a left sidewall, a right sidewall, a forward sidewall, and a rear sidewall extend upward integrally enclosing the bottom wall and forming a front compartment, the left sidewall, the right sidewall, the forward sidewall, and the rear sidewall collectively form a contiguous, continuous upper edge;
a rear body section, the front body section and the rear body section are integrally joined via an interface defining a fold section about which the front body section and the rear body section are foldable to a planar, fully open condition and to an appositional, closed condition, the rear body section comprises a bottom wall comprising a perimetric interface from which a left sidewall, a right sidewall, a forward sidewall, and a rear sidewall extend upward integrally enclosing the bottom wall and forming a rear compartment, the left sidewall, the right sidewall, the forward sidewall, and the rear sidewall collectively form a contiguous, continuous upper edge, and wherein the rear body section further comprises a supplemental large pocket suitably affixed superjacent an outer surface of the bottom wall of the rear body section;
a solar panel charger, the solar panel charger is lightweight and portable, and wherein the solar panel charger is sized and dimensioned so as to be storable in the supplemental large pocket, the supplemental large pocket being sizably dimensioned for securably accommodating and storing the solar panel charger;
a closure, the closure selectively connects the front body section and the rear body section; and
a handle comprising a front crescent-shaped strap affixed to the front body section and a rear crescent-shaped strap affixed to the rear body section, wherein the front crescent-shaped strap is detachably coupled to the rear crescent-shaped strap, thereby forming the handle.

2. The case of claim 1, wherein the front compartment comprises a large pocket for securably storing and organizing at least one larger-sized outdoor grilling accessory.

3. The case of claim 2, wherein the large pocket comprises a panel comprising an upper end opposing a lower end, the upper end having an openable mouth providing direct open passage into an interior storage compartment within which the at least one larger-sized outdoor grilling accessory is stored, and wherein the large pocket dimensionally occupies a substantial majority of a surface area defining an inner surface of the bottom wall.

4. The case of claim 3, wherein the panel is constructed of a durable, elastic mesh or web textile material, the durable, elastic mesh or web textile material applies and maintains a compressive force against the at least one larger-sized outdoor grilling accessory stored inside the interior storage compartment, thereby securably retaining, storing, and organizing the at least one larger-sized outdoor grilling accessory.

5. The case of claim 4, wherein the upper end of the panel is oriented perpendicular to the rear sidewall and proximately parallel to the right sidewall of the front compartment, the upper end is constructed of a durable, elastic fabric band.

6. The case of claim 1, wherein the rear compartment comprises a series of retainers for securably storing and organizing outdoor grilling accessories in a spaced, horizontal orientation.

7. The case of claim 6, wherein the series of retainers comprises a plurality of straps spatially-aligned and oriented intermediate about and perpendicular to the forward sidewall of the rear body section, wherein each of the plurality of straps comprises one end opposing a free end, the one end is suitably affixed an inner surface of the bottom wall of the rear body section, the free end is detachably coupled to the inner surface of the bottom wall of the rear body section via a coupling means.

8. The case of claim 7, wherein each of the plurality of straps overlaps an outdoor grilling accessory in a snug, taut manner, and the free end of each of the plurality of straps is detachably coupled to the inner surface of the bottom wall of the rear body section via the coupling means, thereby securably retaining, storing and organizing the outdoor grilling accessories.

9. The case of claim 6, wherein the rear compartment further comprises a plurality of herb and spice jar retainers.

10. The case of claim 9, wherein plurality of herb and spice jar retainers comprises a series of elastic loops suitably affixed superpositional an inner surface of the bottom wall of the rear body section in a longitudinally-aligned spaced orientation, adjacent the rear sidewall of the rear body section and perpendicular to the series of retainers.

11. The case of claim 10, wherein the series of elastic loops each being sizably-dimensioned to slidably-receive and retain commercially-available herb and spice jars in a snug-fit, secured manner, the series of elastic loops each snugly encompasses an external circumferential sidewall of the commercially-available herb and spice jar.

12. The case of claim 11, wherein the series of elastic loops each snugly encompasses the external circumferential sidewall of a commercially-available herb and spice jar comprising a diametral measure in a range comprising 3.50 cm to 5.50 cm.

13. The case of claim 11, wherein the series of elastic loops each snugly encompasses the external circumferential sidewall of a commercially-available herb and spice jar comprising a diametral measure in a range comprising 4.00 cm to 5.00 cm.

14. The case of claim 11, wherein the series of elastic loops each snugly encompasses the external circumferential sidewall of a commercially-available herb and spice jar comprising a diametral measure in a range comprising 4.25 cm to 4.75 cm.

15. The case of claim 1, wherein the supplemental large pocket is constructed of a durable, elastic mesh or web textile material, the durable, elastic mesh or web textile material applies and maintains a compressive force against the at least one larger-sized outdoor grilling accessory and the one or more outdoor grilling accessories stored inside the supplemental large pocket, thereby securably retaining, storing, and organizing the at least one larger-sized outdoor grilling accessory.

16. The case of claim 15, wherein the supplemental large pocket is constructed of a durable, elastic mesh or web textile material, the durable, elastic mesh or web textile material applies and maintains a compressive force against the solar panel charger stored inside the supplemental large pocket, thereby securably retaining, storing, and organizing the solar panel charger.

17. The case of claim 1, wherein the body assembly further comprises a water repellant liner disposed superpositional an inner surface of a front compartment of the front body section and an inner surface of a rear compartment of the rear body section.

18. The case of claim 17, wherein the body assembly further comprises an insulating layer disposed between the water repellent liner and the inner surface of the front compartment of the front body section and the inner surface of the rear compartment of the rear body section.

19. The case of claim 1, wherein the solar panel charger having insulated wiring electrically connected thereto, the wiring terminates into a male interface connector.

20. The case of claim 19, wherein the male interface connector is selected from the group consisting of a USB 2.0 type A connector, a USB 3.0 type A connector, mini-USB type B connector, a micro-USB type B connector, a USB-C connector, and a lightning connector.
